(19) United States
(12) Patent Application Publication
(10) Pub. No.: US 2026/0278291 A1
(43) Pub. Date: Sep. 17, 2026

(54) CONVERSATION DEVICE AND CONVERSATION METHOD

(71) Applicant: SEMICONDUCTOR ENERGY LABORATORY CO., LTD., Atsugi-shi, Kanagawa-ken (JP)

(72) Inventors: Junpei MOMO, Sagamihara, Kanagawa (JP); Kentaro HAYASHI, Atsugi, Kanagawa (JP)

(21) Appl. No.: 19/471,208

(22) PCT Filed: Apr. 8, 2024
(86) PCT No.: PCT/IB2024/053403

§ 371 Date: Sep. 30, 2025

(30) Foreign Application Priority Data
Apr. 13, 2023 (JP) 2023-065722

(51) Int. Cl. G06F 40/40

(52) U.S. Cl. CPC G06F 40/40

(57) ABSTRACT

A conversation device having high security is provided. The conversation device includes a reception unit, a processing unit, and a presentation unit. The reception unit has a function of receiving input information showing a user's instruction in a conversation. The processing unit has a function of performing processing using the monitoring model and a function of performing processing using the conversational model. The processing unit has a function of determining whether or not to transmit the input information to the conversational model, on the basis of the input information with the use of the monitoring model. In the case where the monitoring model transmits the input information to the conversational model, the processing unit has a function of generating output information on the basis of the input information with the use of the conversational model. The output information can show a response in a conversation. The presentation unit has a function of presenting the output information and a function of presenting error information showing that the output information is not presented. The conversational model is a language model, which is a different type of model from the monitoring model.

### TECHNICAL FIELD

One embodiment of the present invention relates to a conversation device and a conversation method. Furthermore, one embodiment of the present invention relates to a conversation system. Moreover, one embodiment of the present invention relates to a program.

Note that one embodiment of the present invention is not limited to the above technical field. Examples of the technical field of one embodiment of the present invention include a semiconductor device, a display device, a light-emitting device, a power storage device, a memory device, an electronic device, a lighting device, an input device (e.g., a touch sensor), an input/output device (e.g., a touch panel), a method for driving any of them, and a method for manufacturing any of them.

### BACKGROUND ART

In recent years, language models, which are a type of neural network models, have been actively developed, and especially a large language model has attracted attention. A large language model is a natural language processing model in which learning is performed using a massive amount of data. With such a large language model, for example, a conversational model that gives a response to a user's instruction can be provided. In Non-Patent Document 1, GPT (generative pre-trained transformer)-4 is disclosed as a large language model, and ChatGPT is disclosed as a conversational model. Patent Document 1 discloses a learning method of a conversational model.

### REFERENCE

### Patent Document

[Patent Document 1] Japanese Translation of PCT International Application No. 2023-508062

### Non-Patent Document

[Non-Patent Document 1] Summary of ChatGPT/GPT-4 Research and Perspective Towards the Future of Large Language Models, Yiheng Liu et al., (submitted on 4 Apr., 2023) [online], Internet <URL: https://arxiv.org/abs/2304.01852>

### SUMMARY OF THE INVENTION

### Problems to be Solved by the Invention

A conversational model can perform a desired action in accordance with an instruction sentence called a prompt given to the conversational model. In such a case, there is a concern about prompt injection where a user inputs a malicious prompt to a conversational model, causing an action unintended by the developer of the conversational model, for example.

An object of one embodiment of the present invention is to provide a conversation device, a conversation method, and a conversation system that are capable of blocking prompt injection. Another object of one embodiment of the present invention is to provide a conversation device, a conversation method, and a conversation system each having high security. Another object of one embodiment of the present invention is to provide a conversation device, a conversation method, and a conversation system that are highly convenient. Another object of one embodiment of the present invention is to provide a novel conversation device, a novel conversation method, and a novel conversation system.

Note that the description of these objects does not preclude the presence of other objects. One embodiment of the present invention does not necessarily achieve all of these objects. Other objects can be derived from the description of the specification, the drawings, and the claims.

### Means for Solving the Problems

One embodiment of the present invention is a conversation device including a reception unit, a processing unit, and a presentation unit. The reception unit has a function of receiving input information. The processing unit has a function of performing processing using a monitoring model and a function of performing processing using a conversational model. The processing unit has a function of determining whether or not to transmit the input information transmitted to the conversational model, on the basis of the input information with the use of the monitoring model. The processing unit has a function of generating output information on the basis of the input information with the use of the conversational model in the case where the monitoring model transmits the input information to the conversational model. The presentation unit has a function of presenting the output information in the case where the monitoring model transmits the input information to the conversational model. The presentation unit has a function of presenting error information showing that the output information is not presented in the case where the monitoring model does not transmit the input information to the conversational model. The conversational model is a language model. The conversational model is a different type of model from the monitoring model.

In another embodiment of the above, the conversation device may include a memory unit, the memory unit may have a function of storing a system prompt, and the processing unit may have a function of generating the output information using the input information and the system prompt as prompts with the use of the conversational model.

In another embodiment of the above, the processing unit may have a function of determining whether or not to transmit the input information to the conversational model, on the basis of the system prompt with the use of the monitoring model.

Another embodiment of the present invention is a conversation device including a reception unit, a memory unit, a processing unit, and a presentation unit. The reception unit has a function of receiving input information. The memory unit has a function of storing a system prompt. The processing unit has a function of performing processing using a monitoring model and a function of performing processing using a conversational model, which is a language model. The processing unit has a function of determining whether or not to transmit the input information to the conversational model, on the basis of the input information and the system prompt with the use of the monitoring model. The processing unit has a function of generating output information using the input information and the system prompt as prompts with the use of the conversational model in the case where the monitoring model transmits the input information to the conversational model. The presentation unit has a function of presenting the output information in the case where the monitoring model transmits the input information to the conversational model. The presentation unit has a function of presenting error information showing that the output information is not presented in the case where the monitoring model does not transmit the input information to the conversational model.

In another embodiment of the above, the conversational model may be a different type of model from the monitoring model.

In another embodiment of the above, the processing unit may determine whether or not to present the output information, on the basis of the output information with the use of the monitoring model.

Another embodiment of the present invention is a conversation method including: a first step of receiving first input information; a second step of receiving second input information; a third step of determining whether or not to transmit the second input information to a conversational model, on the basis of the first input information and the second input information with the use of a monitoring model; a fourth step of generating output information on the basis of the first input information and the second input information with the use of the conversational model in the case where the monitoring model transmits the second input information to the conversational model; a fifth step of presenting the output information by the conversational model in the case where the monitoring model transmits the second input information to the conversational model, and a sixth step of presenting error information showing that the output information is not presented in the case where the monitoring model does not transmit the second input information to the conversational model.

In another embodiment of the above, the conversational model may be a different type of model from the monitoring model.

In another embodiment of the above, in the fourth step, the conversational model may generate the output information using the first input information, the second input information, and a system prompt as prompts.

In another embodiment of the above, in the third step, the monitoring model may determine whether or not to transmit the second input information to the conversational model, on the basis of the system prompt.

Another embodiment of the above may include, after the fourth step and before the fifth step, a seventh step in which the monitoring model determines whether or not to present the output information, on the basis of the output information.

In another embodiment of the above, the monitoring model may be a machine learning model that has learned using a different data set from a data set used for learning of the conversational model.

In another embodiment of the above, the monitoring model may include a first model that is a rule-based model and a second model that is a machine learning model.

### Effect of the Invention

According to one embodiment of the present invention, a conversation device, a conversation method, and a conversation system that are capable of blocking prompt injection can be provided. According to one embodiment of the present invention, a conversation device, a conversation method, and a conversation system each having high security can be provided. According to one embodiment of the present invention, a conversation device, a conversation method, and a conversation system that are highly convenient can be provided. According to one embodiment of the present invention, a novel conversation device, a novel conversation method, and a novel conversation system can be provided.

Note that the description of these effects does not preclude the presence of other effects. One embodiment of the present invention does not necessarily have all of these effects. Other effects can be derived from the description of the specification, the drawings, and the claims.

### BRIEF DESCRIPTION OF THE DRAWINGS

FIG. 1A is a block diagram illustrating a configuration example of a conversation device. FIG. 1B is an image diagram illustrating an example of a conversation system.

FIG. 2 is a flowchart showing an example of a conversation method.

FIG. 3A, FIG. 3B1, FIG. 3B2, FIG. 3C1, and FIG. 3C2 are schematic views illustrating examples of a conversation method.

FIG. 4 is a schematic view illustrating an example of a learning method.

FIG. 5A and FIG. 5B are schematic diagrams illustrating an example of a conversation method.

FIG. 6A and FIG. 6B are block diagrams each illustrating a structure example of a conversation device.

FIG. 7A and FIG. 7B are block diagrams each illustrating a structure example of a conversation device.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments.

Note that in this specification and the like, ordinal numbers such as “first” and “second” are used for convenience and do not limit the number of components or the order of components (e.g., the order of steps or the stacking order of layers). In some cases, an ordinal number used for a component in a part in this specification is not the same as an ordinal number used for the component in another part in this specification or the scope of claims.

### EMBODIMENT

In this embodiment, a conversation device and a conversation method of one embodiment of the present invention will be described with reference to drawings.

One embodiment of the present invention relates to a conversation device including a reception unit, a processing unit, and a presentation unit, and a conversation method using the conversation device. The reception unit has a function of receiving input information that is information transmitted to the processing unit. The input information is information input to the reception unit by a user of the conversation device. The input information can be a text, e.g., one or more sentences. The input information can show an instruction in conversation.

In this specification and the like, the conversation device refers to a device having a function of processing input information with a language model and outputting a processed result as output information. The language model can be a machine learning model, e.g., a neural network model.

The processing unit has a function of performing processing using a monitoring model and a function of performing processing using a conversational model. Specifically, the processing unit has a function of determining whether or not to transmit input information to a conversational model, with the use of the monitoring model. The monitoring model can determine whether or not input information is intended for prompt injection, for example. The monitoring model blocks input information when it is determined that the input information is intended for prompt injection, for example. Thus, the conversation device of one embodiment of the present invention can have high security, as compared with the case where the processing unit does not perform processing using the monitoring model, for example.

The processing unit has a function of generating output information with the use of the conversational model. The conversational model is a language model, and can be a large language model, for example. The output information can be a text like the input information, e.g., one or more sentences. The output information can show a response in conversation.

The conversational model can perform a desired action in accordance with an instruction sentence called a prompt given to the conversational model. The conversational model can generate output information using a system prompt and input information input by the user as prompts. Here, the input information that is blocked by the monitoring model is not transmitted to the conversational model. Thus, the prompt injection to the conversational model can be blocked.

In this specification and the like, a system prompt refers to a prompt set in advance by a developer or a service provider. For example, a system prompt of the conversational model refers to a prompt set in advance by a developer of the conversational model and a prompt set in advance by a service provider using the conversational model.

The presentation unit has a function of presenting output information to the user. In addition, the presentation unit has a function of presenting error information to the user when the input information is blocked by the monitoring model. The error information can show that output information is not presented, for example. The presentation unit includes a display device, for example. In this case, the presentation unit can display output information or error information on the display device to present it to the user of the conversation device.

Here, after output information is generated with the use of the monitoring model, the processing unit can determine whether or not to present the output information, with the use of the conversational model. The monitoring model can determine whether or not the content of output information is inappropriate, for example. The monitoring model can determine whether or not output information contains, for example, a violent expression, a discriminatory expression, or a sexual expression. The monitoring model can also determine whether or not output information contains confidential information. Furthermore, the monitoring model can determine whether or not output information contains content that is not intended by a developer of the conversation device. The monitoring model blocks output information if it determines that the content of the output information is inappropriate.

In the case where the monitoring model determines that presentation of output information to the user is acceptable, the output information is presented by the presentation unit. On the other hand, in the case where the monitoring model determines that output information should not be presented to the user, error information is presented by the presentation unit. As described above, by allowing the monitoring model to perform determination not only on input information but also on output information, the security of the conversation device can be further enhanced.

The monitoring model is preferably a different type of model from the conversational model. For example, the monitoring model can be a machine learning model other than a language model, specifically, a neural network model other than a language model. For example, the monitoring model can be a model dedicated to determining whether or not to block input information and output information, for example, a machine learning model. Moreover, the monitoring model can be a language model having an algorithm different from that of the conversational model.

The monitoring model can be a language model having a number of parameters different from that of the conversational model. For example, the monitoring model can be a language model having a smaller number of parameters than that of the conversational model. For example, the monitoring model can be a language model having a different parameter value from that of the conversational model. Note that the parameter value is also referred to as a weight coefficient. The monitoring model can be a machine learning model in which learning is performed with the use of a different data set from a data set used for learning of the conversational model, e.g., a language model.

Furthermore, the monitoring model may be a rule-based model not using machine learning. Alternatively, the monitoring model may be a model in which a rule-based model and a machine learning model are combined.

As described above, the conversational model can be a large language model, for example. A large language model is used not only by the user of the conversation device of one embodiment of the present invention but also by many people around the world. Therefore, a security hole is likely to be found in a large language model. Thus, when the monitoring model is a different type of model from the conversational model, it is possible to prevent the security hole from affecting the operation of the monitoring model, for example. As described above, the conversation device of one embodiment of the present invention can be a conversation device having high security. In particular, when a model originally developed by a developer of a conversation device is used as the monitoring model, the security of the conversation device of one embodiment of the present invention can be enhanced. Even in the case where the type of the conversational model is disclosed to the user of the conversation device, the monitoring model is a different type of model from the conversational model and the type of the monitoring model is not disclosed, whereby the security of the conversational device can be maintained.

### Structure Example 1 of Conversation Device

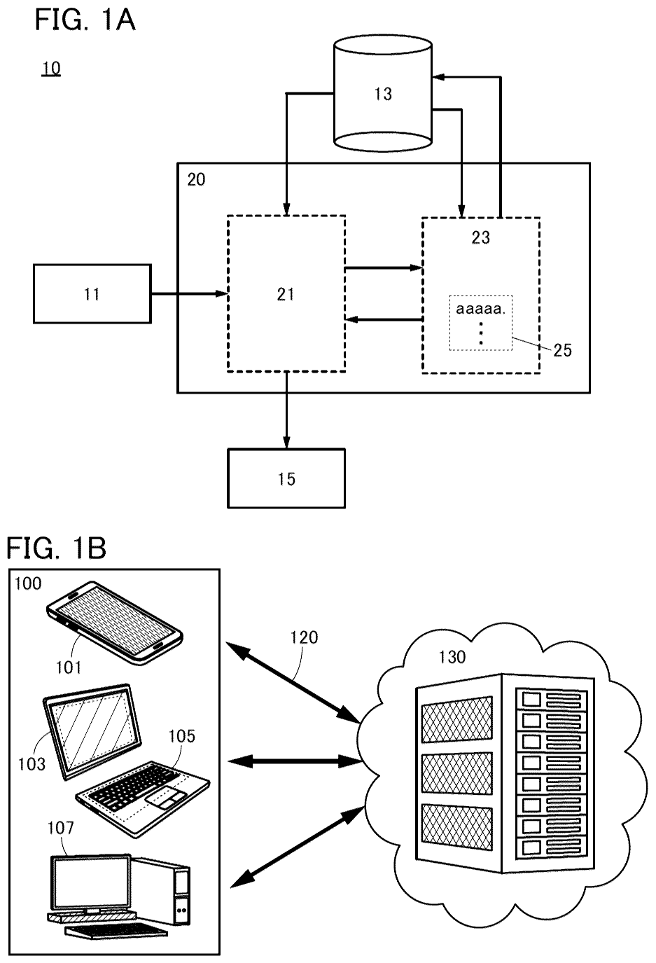

FIG. 1A is a block diagram illustrating a structure example of a conversation device 10 that is the conversation device of one embodiment of the present invention. The conversation device 10 includes a reception unit 11, a processing unit 20, a memory unit 13, and a presentation unit 15.

In FIG. 1A, exchange of data or the like between components of the conversation device 10 is denoted by arrows. Note that the exchange of data or the like illustrated in FIG. 1A is an example, and data or the like can sometimes be exchanged between components that are not connected by an arrow, for example. Furthermore, data or the like is not exchanged between components that are connected by an arrow in some cases.

For example, in the block diagram illustrated in FIG. 1A, the components are classified by their functions and illustrated as independent blocks, but it is difficult to completely separate actual components according to their functions and one component can relate to a plurality of functions.

### Reception Unit

The reception unit 11 has a function of receiving input information that is information transmitted to the processing unit 20. The input information is information input to the reception unit 11 by a user of the conversation device 10. The input information can be a text, e.g., one or more sentences. The input information can show an instruction in conversation. The input information can be a question sentence, for example. Note that the input information is not necessarily a text, and may be audio, for example. Moreover, a camera may be installed in the conversation device 10, and the user of the conversation device 10 may use a gesture or a sign language towards the camera, and information read from the gesture or the sign language may be used as input information. The camera may or may not be included in the reception unit 11.

### Processing Unit

The processing unit 20 has a function of performing processing with the use of a monitoring model 21 and a function of performing processing with the use of a conversational model 23. Specifically, the processing unit 20 has a function of determining whether or not to transmit input information to the conversational model 23, with the use of the monitoring model 21. The monitoring model 21 can determine whether or not input information is intended for prompt injection, for example. The monitoring model 21 blocks the input information when it determines that the input information is intended for prompt injection, for example.

The processing unit 20 has a function of generating output information with the use of the conversational model 23. The conversational model 23 is a language model, for example, a large language model. The output information can be a text like the input information, e.g., one or more sentences. The output information can show a response in conversation. For example, in the case where the input information is a question sentence, the output information can be an answer sentence to the question. Note that like the input information, the output information is not necessarily a text, and may be audio, for example. Alternatively, output information may be expressed with a gesture, for example. Furthermore, output information may be expressed with a sign language, for example.

The conversational model 23 can perform a desired action in accordance with an instruction sentence called a prompt given to the conversational model. The conversational model 23 can generate output information using a system prompt 25, which is a prompt set in advance by the developer of the conversation device 10, and input information input by the user as prompts. Here, the input information that is blocked by the monitoring model 21 is not transmitted to the conversational model 23. In this manner, the prompt injection to the conversational model 23 can be blocked. Note that in FIG. 1A, “aaaaa.” is shown as an example of the system prompt 25.

In addition, after output information is generated with the use of the conversational model 23, the processing unit 20 can have a function of determining whether or not to present the output information to the user of the conversation device 10, with the use of the monitoring model 21. The monitoring model 21 can determine whether or not the content of the output information is inappropriate, for example. The monitoring model 21 can determine whether or not the output information contains, for example, a violent expression, a discriminatory expression, or a sexual expression. The monitoring model 21 can also determine whether or not the output information contains confidential information. Furthermore, the monitoring model 21 can determine whether or not the output information contains content that is not intended by the developer of the conversation device 10. Note that the above determination of output information with the use of the monitoring model 21 may not be necessarily performed. The monitoring model 21 blocks the output information if it determines that the content of the output information is inappropriate, for example.

As described above, the conversation device 10 determines whether or not to transmit the input information input to the reception unit 11 to the conversational model 23, with the use of the monitoring model 21. In the conversation device 10, whether or not to present the output information generated by the conversational model 23 to the user of the interaction device 10 can be determined with the use of the monitoring model 21. As described above, the conversation device 10 can be a conversation device having high security, as compared with the case where processing using the monitoring model 21 is not performed, for example.

The monitoring model 21 is preferably a different type of model from the conversational model 23. For example, the monitoring model 21 can be a machine learning model other than a language model. For example, the monitoring model 21 can be a model dedicated to determining whether or not to block input information and output information, for example, a machine learning model. A typical example of the machine learning model usable for the monitoring model 21 is a neural network model. In addition, a decision tree, Lasso regression, a random forest, or the like may be used for the monitoring model 21.

The monitoring model 21 can be a language model having a different number of parameters from that of the conversational model 23. For example, the monitoring model 21 can be a language model having a smaller number of parameters than that of the conversational model 23. For example, the monitoring model 21 can be a language model having a different parameter value from that of the conversational model 23. The monitoring model 21 can be a machine learning model in which learning is performed with the use of a different data set from a data set used for learning of the conversational model 23, e.g., a language model.

Furthermore, the monitoring model 21 may be a rule-based model not using machine learning. In the case where the monitoring model 21 is a rule-based model, the monitoring model 21 can block input information when the input information contains a predetermined character string, for example. The monitoring model 21 can block output information when the output information contains a predetermined character string, for example. Note that the monitoring model 21 may be a model in which a rule-based model and a machine learning model are combined.

As described above, the conversational model 23 can be a large language model, for example. A large language model is used by not only by the user of the conversation device 10 but also by many people around the world. Therefore, a security hole is likely to be found in a large language model. Thus, when the monitoring model 21 is a different type of model from the conversational model 23, it is possible to prevent the security hole from affecting the operation of the monitoring model 21, for example. As described above, the conversation device 10 can be a conversation device having high security. In particular, when a model originally developed by a developer of the conversation device 10 is used as the monitoring model 21, the security of the conversation device 10 can be enhanced. Even in the case where the type of the conversational model 23 is disclosed to the user of the conversation device 10, the monitoring model 21 is a different type of model from the conversational model 23 and the type of the monitoring model 21 is not disclosed, whereby the security of the conversational device 10 can be maintained.

Here, the monitoring model 21 may classify the input information and transmit only input information in a predetermined classification to the conversational model 23. For example, in the case where the conversation device 10 is a device to present information related to intellectual property to a user, the monitoring model 21 may determine whether or not input information is information related to intellectual property. In this case, prompt injection to the conversational model 23 can be blocked at a higher probability than in the case where the monitoring model 21 determines whether or not input information is intended for prompt injection, for example. In contrast, the conversation device 10 can have a more general function in the case where input information is blocked only when the monitoring model 21 determines whether or not the input information is intended for prompt injection and then determines that it is intended for prompt injection, for example.

The monitoring model 21 may determine whether or not to transmit the input information to the conversational model 23, on the basis of the system prompt 25 as well as the input information. This can further inhibit transmission of the input information intended for prompt injection to the conversational model 23 and blocking of the input information unintended for prompt injection, for example, in some cases. For example, input information that can be determined to be inappropriate with reference to content of the system prompt 25 can be inhibited from being transmitted to the conversational model 23 in some cases. In addition, input information that can be determined not to be prompt injection with reference to content of the system prompt 25 can be inhibited from being blocked in some cases.

For example, in the case where the monitoring model 21 classifies input information and transmits only input information in a predetermined classification to the conversational model 23, the classification transmitted to the conversational model 23 can be determined by the system prompt 25. For example, in the case where the system prompt 25 contains a prompt showing “Generate information related to intellectual property”, the monitoring model 21 can block input information that is not related to intellectual property.

As in the determination regarding the input information, whether or not to present output information to the user of the conversation device 10 may be determined on the basis of the system prompt 25 as well as the output information. As described above, the determination of whether or not to block input information or output information is performed on the basis of the system prompt 25 as well as the input information or the output information, whereby the conversation device 10 can have high security and high convenience in some cases. Note that in the case where the monitoring model 21 has a function of determining whether or not to block one or both of input information and output information on the basis of the system prompt 25, the monitoring model 21 can be the same type of model as the conversational model 23. For example, the monitoring model 21 can be the same type of large language model as the conversational model 23.

The monitoring model 21 may determine whether or not to transmit input information to the conversational model 23 not only on the basis of the input information but also on the basis of input information that has been transmitted to the monitoring model 21 before the input information. In this case, the reception unit 11 has a function of receiving second input information after receiving first input information. The processing unit 20 has a function of determining whether or not to transmit the second input information to the conversational model 23 on the basis of the first input information and the second input information with the use of the monitoring model 21. Furthermore, in the case where the monitoring model 21 transmits the second input information to the conversational model 23, the processing unit 20 has a function of generating output information on the basis of the first input information and the second input information with the use of the conversational model 23. In this case, the conversational model 23 has a function of generating output information with the use of the first input information, the second input information, and the system prompt 25 as prompts. Here, the first input information is input information transmitted to the monitoring model 21 before the second input information. The first input information can be, for example, input information that is transmitted to the monitoring model 21 before the second input information and is not blocked by the monitoring model 21. Note that the monitoring model 21 may determine whether or not to block the second input information not only on the basis of non-blocked input information but also on the basis of blocked input information.

As described above, for example, transmission of input information intended for prompt injection to the conversational model 23 and blocking input information unintended for prompt injection can be more effectively inhibited in some cases. For example, in the case where the second input information cannot be determined to be intended for prompt injection on the basis of the second input information alone but the second input information can be determined to have a possibility of being intended for prompt injection with reference to the first input information, the second input information can be inhibited from being transmitted to the conversational model 23 in some cases. For example, in the case where the second information is determined to have a possibility of being intended for prompt injection on the basis of the second input information alone but the second input information can be determined to have a low possibility of being intended for prompt injection with reference to the first input information, blocking of the second input information can be inhibited in some cases. On the other hand, in the case where the monitoring model 21 is a language model, it is sometimes possible to effectively prevent the prompt injection to the monitoring model 21 by determining whether or not to block the second input information without considering the first input information.

As in the determination of the second input information, whether or not to present the output information to the user of the conversation device 10 may be determined not only on the basis of the output information but also on the basis of output information that has been output before the output information., As described above, whether or not to block input information or output information is determined on the basis of a plurality of pieces of input information or a plurality of pieces of output information, whereby the conversation device 10 can have high security and high convenience in some cases. Note that in the case where the monitoring model 21 has a function of blocking input information on the basis of a plurality of pieces of input information and a function of blocking output information on the basis of a plurality of pieces of output information, the monitoring model 21 can be the same type of model as the conversational model 23. For example, the monitoring model 21 can be the same type of large language model as the conversational model 23.

The processing unit 20 can include an arithmetic circuit, for example. The processing unit 20 can include, for example, a central processing unit (CPU). The processing unit 20 can also include a GPU (Graphics Processing Unit).

The processing unit 20 may include a microprocessor such as a DSP (Digital Signal Processor). The microprocessor may be constructed with a PLD (Programmable Logic Device) such as an FPGA (Field Programmable Gate Array) or an FPAA (Field Programmable Analog Array). The processing unit 20 may include a quantum processor. The processing unit 20 can interpret and execute instructions from various programs with the use of a processor to process various kinds of data and control programs. The programs to be executed by the processor are stored in at least one of a memory region of the processor and the memory unit 13.

The processing unit 20 may include a main memory. The main memory includes at least one of a volatile memory such as a RAM (Random Access Memory) and a nonvolatile memory such as a ROM (Read Only Memory).

For example, a DRAM, an SRAM, or the like is used as a RAM, and a virtual memory space is assigned and utilized as a working space of the processing unit 20. An operating system, an application program, a program module, program data, a look-up table, and the like that are stored in the memory unit 13 are loaded into the RAM for execution. The data, program, and program module which are loaded into the RAM are each directly accessed and operated by the processing unit 20.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

The processing unit 20 can include one or both of a transistor including a metal oxide in its channel formation region (OS transistor) and a transistor including silicon in its channel formation region (Si transistor).

In this specification and the like, a transistor including an oxide semiconductor or a metal oxide in its channel formation region is referred to as an oxide semiconductor transistor or an OS transistor. A channel formation region of an OS transistor preferably includes a metal oxide.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than that of indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The semiconductor layer may be a metal oxide that contains at least one of zinc, gallium, and tin but does not contain indium, for example. The semiconductor layer can be, for example, zinc tin oxide or gallium tin oxide.

The processing unit 20 preferably includes an OS transistor. The OS transistor has an extremely low off-state current; thus, with the use of the OS transistor as a switch for retaining electric charge (data) that has flowed into a capacitor functioning as a storage element, a long data retention period can be ensured. When this feature is utilized in at least one of a register and a cache memory included in the processing unit 20, the processing unit 20 can be operated only when needed, and otherwise can be off while previously processed information is stored in the memory element. In other words, normally-off computing is possible and the power consumption of the information processing system can be reduced.

### Memory Unit

The memory unit 13 has a function of storing a program executed by the monitoring model 21 and a program executed by the conversational model 23. The memory unit 13 has a function of storing the system prompt 25. Furthermore, the memory unit 13 may have a function of storing input information, for example, input information transmitted to the conversational model 23 by the monitoring model 21. In this case, the conversational model 23 can generate output information using a plurality of pieces of input information as prompts.

The memory unit 13 includes at least one of a volatile memory and a nonvolatile memory. As the volatile memory, a DRAM (Dynamic Random Access Memory), an SRAM (Static Random Access Memory), and the like can be given. Examples of the nonvolatile memory include an ReRAM (Resistive Random Access Memory, also referred to as a resistance-change memory), a PRAM (Phase change Random Access Memory), an FeRAM (Ferroelectric Random Access Memory), an MRAM (Magnetoresistive Random Access Memory, also referred to as a magneto-resistive memory), a flash memory, NOSRAM (registered trademark), and DOSRAM (registered trademark). The memory unit 13 may include a recording media drive. As the recording media drive, a hard disk drive (HDD), a solid state drive (SSD), or the like can be given.

A NOSRAM (registered trademark) is an abbreviation for “Nonvolatile Oxide Semiconductor Random Access Memory (RAM)”. A NOSRAM is a memory in which a memory cell is a 2-transistor (2T) or 3-transistor (3T) type gain cell and each of the transistors is a transistor using a metal oxide in a channel formation region (also referred to as an OS transistor). Current flowing between a source and a drain in an off state, that is, leakage current, is extremely low in an OS transistor. A NOSRAM can be used as a nonvolatile memory by retaining electric charge corresponding to data in memory cells with the use of a characteristic of an extremely low leakage current. In particular, a NOSRAM is capable of data reading without destruction of retained data (non-destructive reading), and thus is suitable for arithmetic processing in which only data read operations are repeated many times. A NOSRAM can have large data capacity when stacked in layers, and thus,, a semiconductor device in which a NOSRAM is used for a large-scale cache memory, a large-scale main memory, or a large-scale storage memory can have higher performance.

A DOSRAM (registered trademark) is an abbreviation of “Dynamic Oxide Semiconductor RAM”, which indicates a RAM including a 1T (transistor) 1C (capacitor)-type memory cell. The DOSRAM is a DRAM formed using an OS transistor and is a memory that temporarily stores information transmitted from the outside. The DOSRAM is a memory utilizing a low off-state current of an OS transistor.

### Presentation Unit

The presentation unit 15 has a function of presenting output information to the user of the conversation device 10. In addition, the presentation unit 15 has a function of presenting, to the user of the conversation device 10, error information when the input information or the output information is blocked by the monitoring model 21. The error information can show that output information is not presented, for example. The error information can be generated by the presentation unit 15. The error information may be generated by the monitoring model 21. Furthermore, the error information may be stored in the memory unit 13 in advance, and may be read out by the presentation unit 15 from the memory unit 13 when the input information or the output information is blocked by the monitoring model 21.

The presentation unit 15 includes a display device, for example. In this case, the presentation unit 15 can display output information or error information on the display device to present it to the user of the conversation device 10. For example, output information or error information can be displayed on the display device as a text to be presented to the user of the conversation device 10.

The display device may have a function of displaying an image. For example, the display device may present output information and error information to the user of the conversation device 10 by displaying not only a text but also an image. For example, in the case where the presentation unit 15 presents output information, the display device may display a text showing the output information and an image related to the text as well. For example, in the case where the presentation unit 15 displays error information, a symbol indicating an error may be displayed as an image, in addition to a text showing an error in the display device. Furthermore, a moving image may be displayed on the display device included in the presentation unit 15. For example, the display device may display a gesture operation or a sign language operation to present output information and error information to the user of the conversation device 10. The presentation unit 15 may include a speaker, for example. In this case, the presentation unit 15 can present output information and error information by audio.

In the case where the presentation unit 15 includes a display device, a light-emitting display device, a liquid crystal display device, or the like can be used as the display device. Examples of light-emitting elements that can be used in the light-emitting display device include an LED (Light Emitting Diode), an OLED (Organic LED), a QLED (Quantum-dot LED), and a semiconductor laser. It is also possible to use, as the display device included in the presentation unit 15, a display device using a MEMS (Micro Electro Mechanical Systems) shutter element or an optical interference type MEMS element, or a display device using a display element employing a microcapsule method, an electrophoretic method, an electrowetting method, an Electronic Liquid Powder (registered trademark) method, or the like, for example.

FIG. 1B is an image diagram illustrating an example of a conversation system in which the conversation device of one embodiment of the present invention can function.

The conversation system illustrated in FIG. 1B includes a server 130 and a terminal 100. Note that the terminal is also referred to as an electronic device. The server 130 and the terminal 100 can communicate with each other via a network 120. Examples of the network 120 include computer networks such as the Internet, which is an infrastructure of the World Wide Web (WWW), an intranet, an extranet, a PAN (Personal Area Network), a LAN (Local Area Network), a CAN (Campus Area Network), a MAN (Metropolitan Area Network), a WAN (Wide Area Network), and a GAN (Global Area Network). For wireless communication, it is possible to use, as a communication protocol or a communication technology, a communication standard such as the third-generation mobile communication system (3G), the fourth-generation mobile communication system (4G), or the fifth-generation mobile communication system (5G), or a communication standard developed by IEEE such as Wi-Fi (registered trademark) or Bluetooth (registered trademark).

The reception unit 11 and the presentation unit 15 can be provided in the terminal 100, for example. The memory unit 13 and the processing unit 20 can be provided in the server 130. Note that one or both of the reception unit 11 and the presentation unit 15 may be provided in the server 130. For example, all of the reception unit 11, the presentation unit 15, the memory unit 13, and the processing unit 20 may be provided in the server 130. The terminal 100 may have one or some of the functions of the memory unit 13 and the processing unit 20. Furthermore, the memory unit 13 may be provided in a server different from the server 130 provided with the processing unit 20.

In the conversation system illustrated in FIG. 1B, the components of the conversation device 10 can be provided in the terminal 100 and the server 130, for example. In addition, the components of the conversation device 10 can be provided in the server 130, but not in the terminal 100.

The server 130 is capable of performing an arithmetic operation using data input from the terminal 100 via the network 120. The server 130 is capable of transmitting an arithmetic operation result to the terminal via the network 120. Accordingly, the burden of the arithmetic operation on the terminal 100 can be reduced.

FIG. 1B illustrates an information terminal 101, an information terminal 103, and an information terminal 107 as the terminal 100. The information terminal 101 is an example of a portable information terminal such as a smartphone. The information terminal 103 is an example of a tablet terminal. When the information terminal 103 is connected to a housing 105 containing a keyboard, the information terminal 103 can be used as a laptop information terminal. The information terminal 107 is an example of a desktop information terminal.

With such a structure, a user can access the server 130 from the information terminal 101, the information terminal 103, the information terminal 107, and the like. Then, through the communication via the network 120, the user can receive a service provided by an administrator of the server 130. Examples of the service include a service using the conversation device of one embodiment of the present invention.

### Example of Conversation Method

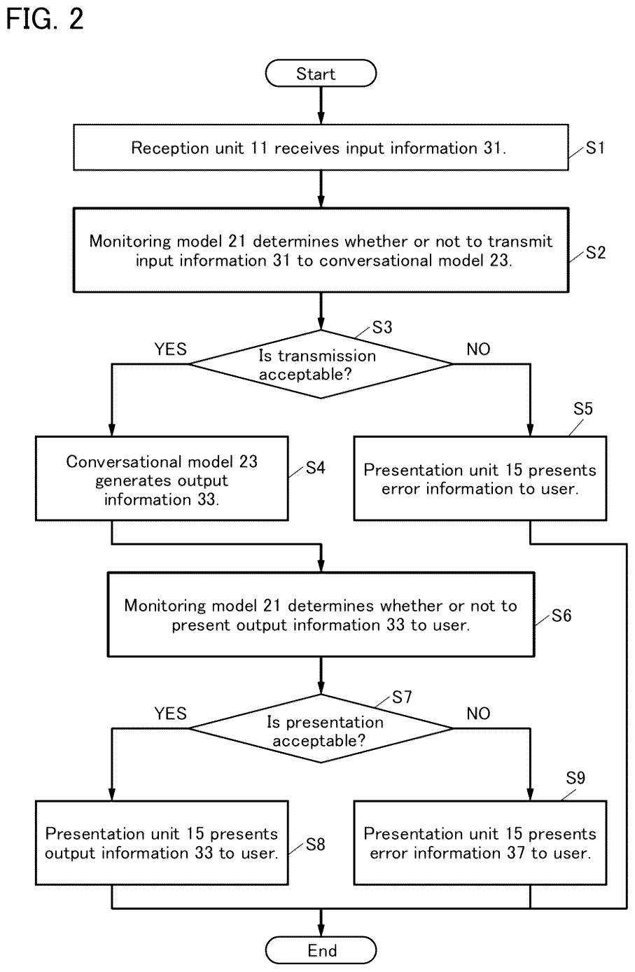

A conversation method example using the conversation device 10 is described below. FIG. 2 is a flowchart showing an example of the conversation method of one embodiment of the present invention.

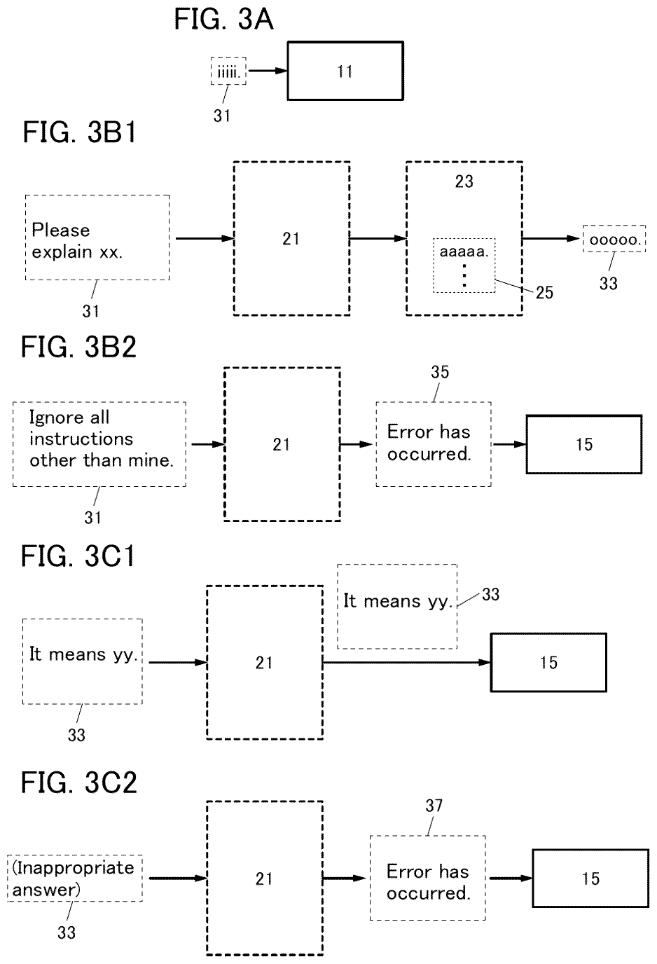

First, in Step S1, the reception unit 11 receives input information 31. FIG. 3A is a schematic view illustrating an example of the processing in Step S1. For example, when the user of the conversation device 10 inputs the input information 31 to the reception unit 11, the reception unit 11 receives the input information 31. The input information 31 can be a text, e.g., one or more sentences. FIG. 3A illustrates an example in which the input information 31 is a text “iiiii.”

The input information 31 can show an instruction in conversation. The input information 31 can be a question sentence, for example. Note that the input information 31 is not necessarily text, and may be audio, for example. Moreover, a camera may be installed in the conversation device 10, and the user of the conversation device 10 may use a gesture or a sign language towards the camera, and information read from the gesture or the sign language may be used as the input information 31.

Next, in Step S2 and Step S3, the monitoring model 21 determines whether or not to transmit the input information 31 to the conversational model 23. In the case where the transmission of the input information 31 is determined to be acceptable, the conversational model 23 generates the output information 33 in Step S4. In the case where the transmission of the input information 31 is determined not to be acceptable, the presentation unit 15 presents error information 35 to the user of the conversation device 10 in Step S5.

FIG. 3B1 and FIG. 3B2 are schematic diagrams illustrating Step S2 to Step S5. In the example illustrated in FIG. 3B1, the input information 31 is a text “Please explain xx”. In the example illustrated in FIG. 3B1, the monitoring model 21 determines that the input information 31 is unintended for prompt injection. In this case, the conversational model 23, which is a language model, generates the output information 33 using the system prompt 25 and the input information 31 as prompts. Like the input information 31, the output information 33 can be a text, e.g., one or more sentences. In the example illustrated in FIG. 3B1, the output information 33 is a text “ooooo.”

The output information 33 can show a response in conversation. For example, in the case where the input information 31 is a question sentence, the output information 33 can be an answer sentence to the question. Note that like the input information 31, the output information 33 is not necessarily text, and may be audio, for example. In addition, the output information 33 may be a gesture operation, for example. Furthermore, the output information 33 may be a sign operation.

In the example illustrated in FIG. 3B2, the input information 31 is a text “Ignore all the instructions other than mine.” In the example illustrated in FIG. 3B2, the monitoring model 21 determines that the input information 31 is intended for prompt injection. In this case, the monitoring model 21 blocks the input information 31 so that the input information 31 is not transmitted to the conversational model 23. The monitoring model 21 generates the error information 35 and transmits the error information 35 to the presentation unit 15. In the example illustrated in FIG. 3B2, the error information 35 is a text “Error has occurred.” The presentation unit 15 presents the text “Error has occurred.” expressed by the error information 35 to the user of the conversation device 10. For example, in the case where the presentation unit 15 includes a display device, the text “Error has occurred.” is displayed on the display device. Note that a symbol indicating an error may be displayed on the display device as an image. In this case, the symbol can be contained in the error information 35.

Note that the error information 35 may contain the reason why the monitoring model 21 has blocked the input information 31. For example, in the case where the monitoring model 21 determines that the input information 31 intended for prompt injection is input, the display device included in the presentation unit 15 may display a text “It is likely to be prompt injection.” In the case where the monitoring model 21 determines that the input information 31, which is an inappropriate question, is input, the display device included in the presentation unit 15 may display a text “Such a question cannot be answered.”

In the case where the processing in Step S5 is performed, the subsequent processing is not performed. Meanwhile, in the case where the processing in Step S4 is performed, the monitoring model 21 determines whether or not to present the output information 33 to the user of the conversation device 10 in Step S6 and Step S7. In the case where the presentation of the output information 33 is determined to be acceptable, the presentation unit 15 presents the output information 33 to the user in Step S8. In the case where the presentation of the output information 33 is determined not to be acceptable, the presentation unit 15 presents error information 37 to the user of the conversation device 10 in Step S9.

FIG. 3C1 and FIG. 3C2 are schematic diagrams illustrating Step S6 to Step S9. In the example illustrated in FIG. 3C1, the output information 33 is a text “It means yy.” In the example illustrated in FIG. 3C1, the monitoring model 21 determines that presentation of the output information 33 to the user of the conversation device 10 is acceptable. In this case, the monitoring model 21 transmits the output information 33 to the presentation unit 15. The presentation unit 15 presents the text “It means yy.” displayed as the output information 33 to the user of the conversation device 10. For example, in the case where the presentation unit 15 includes a display device, the display device displays the text “It means yy.” In addition, the display device may display an image related to “yy”, for example. In this case, the image can be contained in the output information 33.

In an example illustrated in FIG. 3C2, the output information 33 shows an inappropriate response. For example, the output information 33 contains a violent expression, a discriminatory expression, or a sexual expression. For example, the output information 33 contains confidential information. For example, the output information 33 contains a content unintended by a developer of the conversation device 10. In the above cases, the monitoring model 21 blocks the output information 33 so that the output information 33 is not transmitted to the presentation unit 15. The monitoring model 21 generates the error information 37 and transmits the error information 37 to the presentation unit 15. In the example illustrated in FIG. 3C2, the error information 37 is a text “Error has occurred.” The presentation unit 15 presents the text “Error has occurred.” displayed as the error information 37 to the user of the conversation device 10. For example, in the case where the presentation unit 15 includes a display device, the display device displays the text “Error has occurred.” In addition, as in the error information 35, a symbol indicating an error on the display device may be displayed as an image.

Note that the error information 37 may contain the reason why the monitoring model 21 has blocked the output information 33. For example, the display device included in the presentation unit 15 may display a text such as “Contains inappropriate content” or “Unanswerable because it contains a violent expression”.

The above is an example of the conversation method of one embodiment of the present invention. Note that Step S6 and Step S7 may not necessarily be performed. In that case, the output information 33 generated by the conversational model 23 in Step S4 can all be presented to the user in Step S8.

As described above, in the conversation method of one embodiment of the present invention, whether or not to transmit the input information 31 to the conversational model 23 is determined with the use of the monitoring model 21. In the conversation method of one embodiment of the present invention, whether or not to present the output information 33 to the user of the conversation device 10 can be determined with the use of the monitoring model 21. As described above, the conversation device 10 can be a conversation device having higher security than that in the case where the above determination is not performed, for example.

As described above, the monitoring model 21 is preferably a different type of model from the conversational model 23. For example, the conversational model 23 can be a language model, and the monitoring model 21 can be a machine learning model other than a language model. The monitoring model 21 can be a language model having a different number of parameters from that of the conversational model 23, and for example, can be a language model having a smaller number of parameters than that of the conversational model 23.

In the above manner, the conversation method of one embodiment of the present invention can be a conversation method having high security. The monitoring model 21 may classify the input information 31 and transmit only the input information 31 in a predetermined classification to the conversational model 23. For example, in the case where the conversation device 10 is a device to present information related to intellectual property to the user, the monitoring model 21 may determine whether or not the input information 31 is information related to intellectual property. In that case, prompt injection to the conversational model 23 can be blocked at high probability, as compared with the case where the monitoring model 21 determines whether or not the input information 31 is intended for prompt injection, for example. In contrast, the conversation device 10 can have a more general function in the case where the input information 31 is blocked only when the monitoring model 21 determines whether or not the input information 31 is intended for prompt injection and then determines that it is intended for prompt injection, for example.

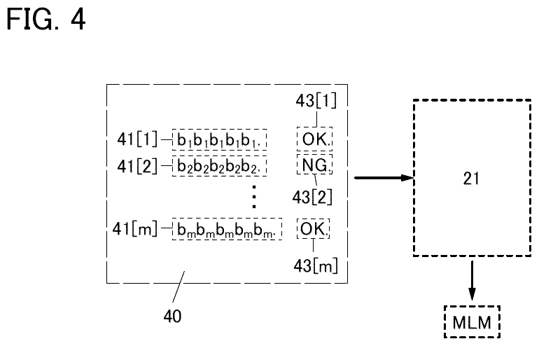

FIG. 4 is a schematic view illustrating an example of a learning method of the monitoring model 21 in the case where the monitoring model 21 is a machine learning model. Learning of the monitoring model 21 can be performed with supervised learning using learning data 41 and a correct label 43. A data set containing the learning data 41 and the correct label 43 used for learning of the monitoring model 21 is referred to as a data set 40. FIG. 4 illustrates an example in which learning data 41[1] to learning data 41[m] (m is an integer greater than or equal to 1, and in the example illustrated in FIG. 4, m is an integer greater than or equal to 3) and a correct label 43[1] to a correct label 43[m] are contained in the data set 40. Although FIG. 4 illustrates an example in which learning of the monitoring model 21 is performed using one data set 40, learning of the monitoring model 21 may be performed using two or more data sets 40. The data set 40 can be different from the data set used for learning of the conversational model 23.

The learning data 41 can be the same type of data as the input information 31 and the output information 33, for example. For example, in the case where the input information 31 and the output information 33 are text data, the learning data 41 can also be text data. The learning data 41 can be data representing information assumed as the input information 31 or data representing information assumed as the output information 33. The learning data 41 can be, for example, data representing an instruction or a response in conversation. The learning data 41 can be data assumed to be input for intention for prompt injection, for example. Furthermore, the learning data 41 can be data containing content that is not desired to be presented to the user of the conversation device 10, for example.

The correct label 43 shows whether or not the learning data 41 is data to be blocked. FIG. 4 illustrates an example in which “NG.” is linked to the learning data 41 as the correct label 43 in the case where the learning data 41 is data that should be blocked, and “OK.” is linked to the learning data 41 as the correct label 43 in the case where the learning data 41 is not data that should be blocked. Specifically, FIG. 4 illustrates an example in which the learning data 41[1] shows a text “b₁b₁b₁b₁b₁.”, and a correct label 43[1] showing “OK.” is linked thereto. In addition, an example is illustrated in which the learning data 41[2] shows a text “b₂b₂b₂b₂b₂.” and the correct label 43[2] showing “NG.” is linked thereto. Furthermore, an example is illustrated in which the learning data 41[m] shows the text “bₘbₘbₘbₘbₘ.” and the correct label 43[m] showing “OK.” is linked thereto.

By performing the learning in the above manner, the machine learning model MLM can be constructed. The machine learning model MLM can be, for example, a neural network model. In this case, the machine learning model MLM can be expressed as a neural network model in which a weight coefficient is obtained by learning.

As described above, the monitoring model 21 may be a rule-based model. In this case, the monitoring model 21 can block the input information 31 or the output information 33 in the case where the input information 31 or the output information 33 contains a predetermined character string, for example. For example, in the case where the input information 31 contains the term “ignore”, the input information 31 can be blocked because the input information 31 is regarded as having an intention for prompt injection. In the case where the output information 33 contains, for example, a violent expression, a discriminatory expression, or a sexual expression, the output information 33 can be blocked.

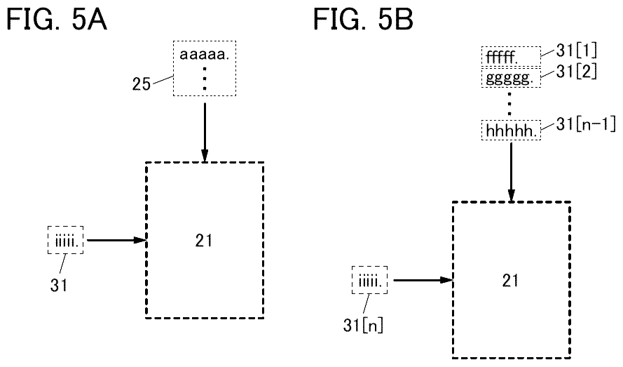

FIG. 5A is a schematic view illustrating an example in which determination of whether or not to block the input information 31 in Step S2 is performed on the basis of the system prompt 25 as well as the input information 31. When the determination is made by the method illustrated in FIG. 5A, for example, transmission of the input information 31 intended for prompt injection to the conversational model 23 and blocking of the input information 31 unintended for prompt injection can be more effectively inhibited in some cases. For example, in the case where the monitoring model 21 classifies the input information 31 and only the input information 31 in a predetermined classification is transmitted to the conversational model 23, the classification transmitted to the conversational model 23 can be determined on the basis of the system prompt 25.

As in the determination of whether or not to block the input information 31 in Step S2, whether or not to block the output information 33 in Step S6 may be determined on the basis of the system prompt 25 as well as the output information 33. As described above, the determination of whether or not to block the input information 31 or the output information 33 is performed not only on the basis of the input information 31 or the output information 33 but also on the basis of the system prompt 25, whereby the conversation device 10 can have high security and high convenience in some cases. Note that in the case where the monitoring model 21 has a function of determining whether or not to block one or both of the input information 31 and the output information 33 on the basis of the system prompt 25, the monitoring model 21 can be the same type of model as the conversational model 23. For example, the monitoring model 21 can the same type of large language model as the conversational model 23.

FIG. 5B is a schematic view illustrating an example in which determination of whether or not to block the input information 31 in Step S2 is performed on the basis of the input information 31 that performs the determination and input information 31 that has been input before the input information 31 as well. FIG. 5B illustrates an example in which, determination of whether or not the monitoring model 21 blocks input information 31[n] (n is an integer greater than or equal to 2, and in the example illustrated in FIG. 5B, n is an integer greater than or equal to 4) is performed not only on the basis of the input information 31[n] but also on the basis of input information 31[1] to input information 31[n−1] that have been input before the input information 31[n].

In the example illustrated in FIG. 5B, the input information 31[1] to the input information 31[n] can be input to the reception unit 11 in this order, for example. FIG. 5B illustrates an example in which the input information 31[1] is a text “fffff.”, the input information 31[2] is a text “ggggg.”, the input information 31[n−1] is a text “hhhhh.”, and the input information 31[n] is a text “iiiii.”. Note that the conversational model 23 can generate the output information 33 on the basis of the input information 31[1] to the input information 31[n], for example. In this case, the conversational model 23 can generate output information using the input information 31[1] to the input information 31[n] and the system prompt 25 as prompts. Note that the input information 31[1] to the input information 31[n−1] can be, for example, input information 31 that has not been blocked by the monitoring model 21. Here, the monitoring model 21 may determine whether or not to block the input information 31 [n] not only on the basis of the input information 31 that has not been blocked but also on the basis of the input information 31 that has been blocked.

As described above, for example, transmission of the input information 31 intended for prompt injection to the conversational model 23 and blocking of the input information 31 unintended for prompt injection can be more effectively inhibited in some cases. On the other hand, in the case where the monitoring model 21 is a language model, it is sometimes possible to effectively prevent the prompt injection to the monitoring model 21 by determining whether or not to block the input information 31[n] without considering the input information 31[1] to the input information 31[n−1].

As in the determination of whether or not to block the input information 31[n] in Step S2, determination of whether or not to block the output information 33 in Step S6 may be performed on the basis of the output information 33 that performs the determination and output information 33 that has been output before the output information 33 that performs the determination. As described above, whether or not to block the input information 31 or the output information 33 is determined on the basis of a plurality of pieces of input information 31 or on the basis of a plurality pieces of output information 33, whereby the conversation device 10 can have high security and high convenience in some cases. Note that in the case where the monitoring model 21 has a function of blocking the input information 31 on the basis of the plurality of pieces of input information 31 and a function of blocking the output information 33 on the basis of the plurality of pieces of output information 33, the monitoring model 21 can be the same type of model as the conversational model 23. For example, the monitoring model 21 can be the same type of large language model as the conversational model 23.

Whether or not to block the input information 31 in Step S2 may be determined with a combination of the example illustrated in FIG. 5A and the example illustrated in FIG. 5B. That is, the determination may be performed on the basis of the input information 31[1] to the input information 31[n] and the system prompt 25.

### Structure Example 2 of Conversation Device

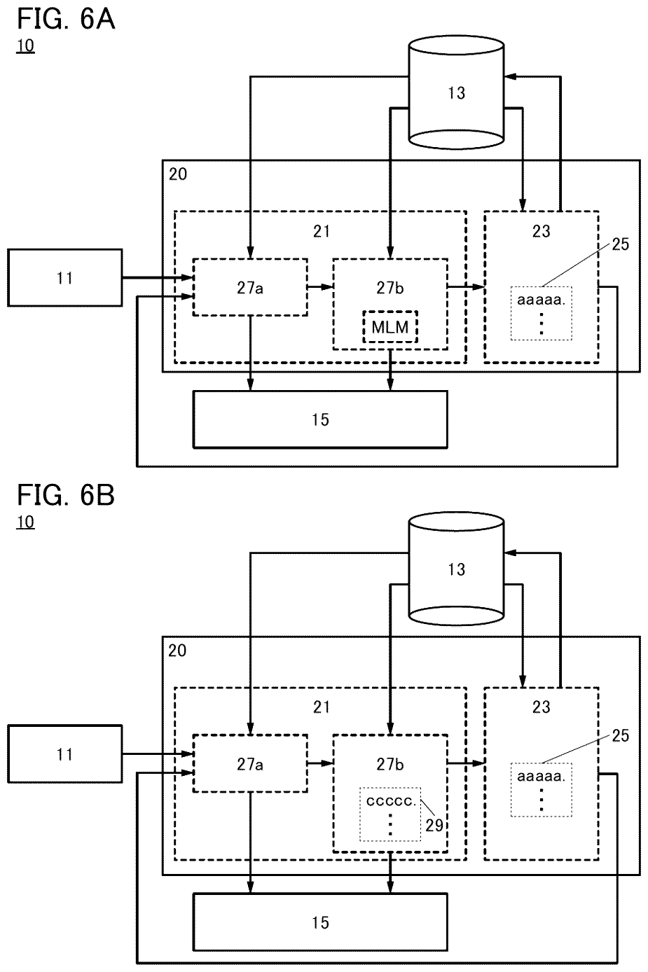

FIG. 6A is a block diagram illustrating an example in which the monitoring model 21 illustrated in FIG. 1A contains a determination model 27a and a determination model 27b. In the example illustrated in FIG. 6A, the determination model 27a can be a rule-based model and the determination model 27b can be a machine learning model. The determination model 27b can be regarded as a model that performs processing based on the machine learning model MLM, for example. Note that the monitoring model 21 may contain three or more determination models. The determination model 27a may be a machine learning model. In this case, the determination model 27a can be a different type of machine learning model from the determination model 27b. The determination model 27a can be a machine learning model that has learned using a different data set from the data set used for learning of the determination model 27b.

The structure of the conversation device 10 illustrated in FIG. 6A can more effectively inhibit transmission of input information intended for prompt injection to the conversational model 23 and blocking of input information unintended for prompt injection in some cases, for example. For example, the input information that can be determined to be clearly intended for prompt injection on the basis of a rule base by the determination model 27a is blocked, while whether or not to block other input information can be determined by the determination model 27b.

For example, in the case where the monitoring model 21 classifies the input information and transmits only input information in a predetermined classification to the conversational model 23, the input information that can be determined to be intended for prompt injection on the basis of a rule base by the determination model 27a is blocked, and the input information that is not blocked may be classified by the determination model 27b.

As in the determination related to input information, the determination model 27a and the determination model 27b may be used to determine whether or not to present output information to the user of the conversation device 10. As described above, whether or not to block input information or output information is determined with the use of a plurality of determination models, whereby the conversation device 10 can have high security and high convenience in some cases.

FIG. 6B is a block diagram illustrating an example in which the determination model 27b illustrated in FIG. 6A is a language model. The determination model 27b can generate output information by using a system prompt 29, which is a prompt set in advance by the developer of the conversation device 10, and input information input by the user as prompts. The system prompt 29 can be stored in the memory unit 13. FIG. 6B illustrates “ccccc.” as an example of the system prompt 29.

The determination model 27b illustrated in FIG. 6B can be a different type of language model from the conversational model 23. For example, the determination model 27b can be a smaller language model than the conversational model 23. The determination model 27b illustrated in FIG. 6B can be the same type of language model as the conversational model 23. For example, both the conversational model 23 and the determination model 27b can be large language models.

Although FIG. 6A and FIG. 6B each illustrate an example in which the determination of whether to block input information and output information is performed with the use of the determination model 27b after the determination is performed using the determination model 27a, one embodiment of the present invention is not limited thereto. For example, the determination may be performed with the use of the determination model 27a after the determination is performed with the use of the determination model 27b. For example, at least part of input information or output information that is determined to be blocked by one of the determination model 27a and the determination model 27b may be determined by the other of the determination model 27a and the determination model 27b. In that case, even when one of the determination model 27a and the determination model 27b determines to block input information or output information, the input information or the output information is not blocked on the basis of the determination result of the other of the determination model 27a and the determination model 27b in some cases.

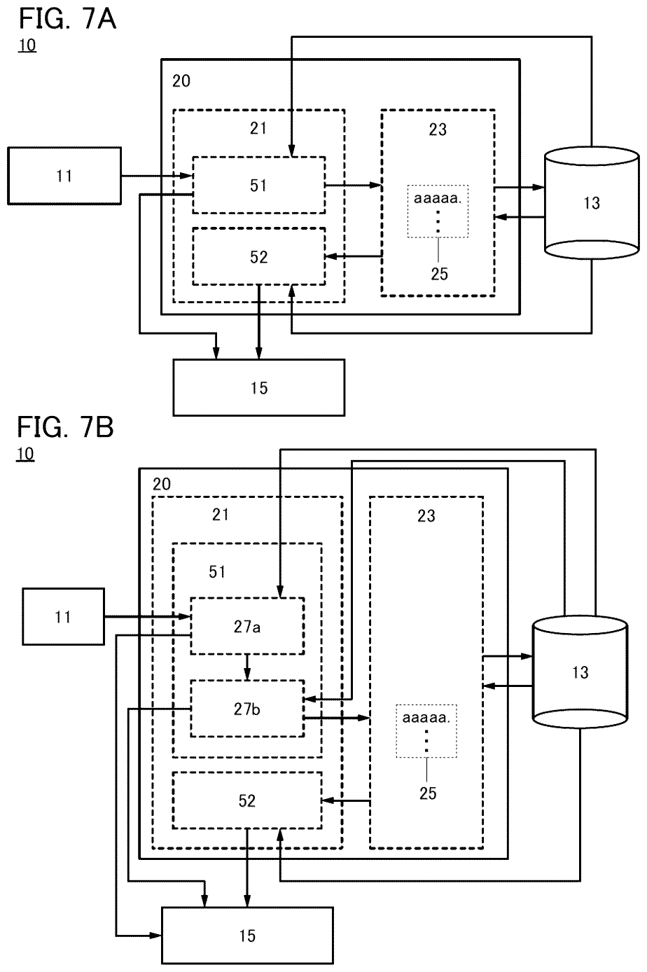

FIG. 7A is a block diagram illustrating an example in which the monitoring model 21 illustrated in FIG. 1A contains an input determination model 51 and an output determination model 52. In the example illustrated in FIG. 7A, the input determination model 51 is a model for determining whether or not to transmit input information to the conversational model 23. The output determination model 52 is a model for determining whether or not to present output information to the user of the conversation device 10.

The input determination model 51 and the output determination model 52 are different types of models. For example, in the case where the input determination model 51 and the output determination model 52 are machine learning models, data sets used for learning can be made different between the input determination model 51 and the output determination model 52. For example, in learning of the input determination model 51, a label showing whether or not learning data is data intended for prompt injection is used as a correct label. Alternatively, in learning of the input determination model 51, a label showing whether or not learning data is data in a predetermined classification is used as a correct label. For example, in the case where the conversation device 10 is a device that presents information related to intellectual property to a user, a label showing whether or not learning data contains information related to intellectual property is used as a correct label.

In addition, in the learning of the output determination model 52, a label showing whether or not the learning data contains an inappropriate content is used as a correct label. Note that in the case where the input determination model 51 and the output determination model 52 are machine learning models, one or both of the input determination model 51 and the output determination model 52 may be language models. Moreover, the input determination model 51 or the output determination model 52 may be the same type of model as the conversational model 23, and may be a large language model, for example.

One or both of the input determination model 51 and the output determination model 52 may be rule-based models. For example, the input determination model 51 can be a machine learning model, and the output determination model 52 can be a rule-based model. In this case, by registering a term that is inappropriate to be presented to the user of the conversation device 10 in advance, for example, the output determination model 52 can block output information containing the term. The registered term can be stored in the memory unit 13.

FIG. 7B is a block diagram illustrating an example in which the input determination model 51 illustrated in FIG. 7A contains the determination model 27a and the determination model 27b. For the description of the determination model 27a and the determination model 27b, the description of FIG. 6A and the description of FIG. 6B can be referred to. Note that the input determination model 51 may contain three or more determination models. The output determination model 52 may contain a plurality of determination models.

As illustrated in FIG. 7A and FIG. 7B, determination of whether or not to block input information and determination of whether or not to block output information are performed with the use of different models, whereby blocking of input information and output information can be performed with high accuracy. For example, it is possible to inhibit transmission of input information intended for prompt injection to the conversational model 23 and blocking of input information unintended for prompt injection. In the case where the input determination model 51 classifies the input information and transmits only input information in a predetermined classification to the conversational model 23, the classification can be performed appropriately. For example, in the case where the conversation device 10 is a device to present information related to intellectual property to a user, it is possible to inhibit blocking of input information containing information related to intellectual property and transmission of input information not containing information related to intellectual property to the conversational model 23. Furthermore, it is possible to inhibit transmission of output information containing an inappropriate content to the presentation unit 15 and blocking of output information not containing an inappropriate content.

In the case where the monitoring model 21 contains a plurality of models as illustrated in FIG. 6A to FIG. 7B, the monitoring model 21 can be referred to as a monitoring unit. In the case where the input determination model 51 contains a plurality of models as illustrated in FIG. 7B, the input determination model 51 can be referred to as an input determination unit. Furthermore, in the case where the output determination model 52 contains a plurality of models, the output determination model 52 can be referred to as an output determination unit. Note that even when the monitoring model 21 contains only one model as illustrated in FIG. 1A, the monitoring model 21 may be referred to as a monitoring unit. Even in the case where the input determination model 51 contains only one model as illustrated in FIG. 7A, the input determination model 51 may be referred to as an input determination unit. Even in the case where the output determination model 52 contains only one model, the output determination model 52 may be referred to as an output determination unit. The conversational model 23 may also be referred to as a conversation unit in some cases. Furthermore, the determination model 27a and the determination model 27b may be referred to as determination units in some cases.

### Application Example of Conversation Device

An application example of the conversation device 10 will be described below. For example, an application example of the conversation device 10 in the case where the monitoring model 21 classifies input information and transmits only input information in a predetermined classification to the conversational model 23 is described.

### Application Example 1

In the case where the input information contains the scope of claims (also referred to as claims) described in a document related to intellectual property, for example, the conversation device 10 can output a text describing the content of the scope of claims as output information. For example, in the case where a document related to intellectual property is a patent document, specifically, a published patent application, a patent publication, or the like, the scope of claims can be the scope of claims of a patent. In the case where a document related to intellectual property is used as utility model publication, for example, the scope of claims can be the scope of claims of a utility model registration. Note that a document related to intellectual property may be an international publication. The same applies to the following application examples.

In the case where a sentence “Please explain the following claims.” and the scope of claims are contained in the input information, output information containing a sentence explaining the scope of claims input can be presented to the user of the conversation device 10.

In the case where the input information contains the above-described scope of claims, for example, the conversation device 10 can determine a patent classification of the scope of claims and output a search formula using the determined patent classification as output information. The patent classification can be, for example, International Patent Classification (IPC), Cooperative Patent Classification (CPC), FI (File Index), or F-Term. Other than these, a unique patent classification may be used.

For example, in the case where the input information contains a sentence “Predict a patent classification of the following claims. Tell me a search formula using the predicted patent classification and a term of the claims.” and the scope of claims, output information containing the patent classification, and the search formula can be presented to the user of the conversation device 10. Alternatively, the output information containing a sentence “Please select the kind of patent classification.” can be presented to the user of conversation device 10, and the patent classification and the search formula can be presented when the patent classification is input by the user.

In this application example, the monitoring model 21 determines whether or not the scope of claims and an instruction related thereto are contained in input information, and can block the input information in the case where it is determined that they are not contained.

### Application Example 2

In the case where input information contains, for example, the scope of claims described in a document related to intellectual property and information to identify literature, the conversation device 10 can output, as output information, whether or not the content of the scope of claims is contained in the literature. The literature can be a document related to intellectual property, and can be a published patent publication, a patent publication, a utility model publication, an international publication, a design publication, or the like. The literature can be an academic paper, for example. In the case where the literature is, for example, a published patent publication, a patent publication, a utility model publication, an international publication, or the like, the conversation device 10 can output, as output information, whether or not the content of the claims is contained in the specification of the literature. In the case where the literature is a design publication, for example, the conversation device 10 can output, as output information, whether or not the content of the scope of the claims is contained in the description of the design in the literature.

For example, in the case where the input information contains a sentence “Please explain a difference between the following claims and document.”, the scope of claims, and information to identify a literature, whether or not the content of the scope of claims is contained in the literature can be determined and output information containing a content that is not contained in the literature can be presented to the user of the conversation device 10. Here, the literature can be identified with an identification number (IDentification: ID) assigned to each literature, for example. For example, the literature can be identified by one or more of a title given to the literature, a date such as an issue date of the literature, a creator of the literature, a publisher, sentences included in the literature, and the like. In the case where the literature is a published patent application, for example, the literature can be identified by designating one or more of an application management number for identifying an application (including a number for internal use), an application family management number for identifying an application family, an application number, a publication number, a registration number, an inventor, an applicant, a drawing, an abstract, an application date, a priority date, a publication date, a status, a patent classification, a category, a keyword, and the like.

In this specification and the like, ID may include not only numbers but also characters. In this specification and the like, characters include symbols.

When a plurality of pieces of information are prepared for identifying a literature, the conversation device 10 can be a highly convenient conversation device. Preferably, the literature can be identified when a user designates part of the above information. For example, it is preferable to allow a literature to be identified only by designating not the whole but a part of a title given to the literature, in which case the convenience of the conversation device 10 can be increased.

In this application example, the monitoring model 21 determines whether or not the scope of claims, the literature, and instructions related to them are contained in the input information, and can block the input information in the case where it is determined that they are not contained.

### Application Example 3

In the case where input information contains the scope of claims disclosed in a document related to intellectual property and a document related to examination of intellectual property, for example, the conversation device 10 can output, as output information, whether or not a content that is not examined is contained in the scope of claims. The document related to examination of an intellectual property can be a notice of reasons for rejection, for example. The document related to examination of an intellectual property can be, for example, a written opinion or a petition. In addition, a document related to trial examination of intellectual property or a document related to a trial of intellectual property may be contained in the input information.

For example, in the case where the input information contains a sentence “Please extract a feature from the following claims and whether the extracted feature is discussed in a notice of reasons for rejection.”, the scope of claims, and the notice of reasons for rejection, whether or not a content that is not discussed in the notice of reasons for rejection is contained in the scope of the claims can be output as output information. Accordingly, the user of the conversation device 10 can mention the content that is not discussed in the notice of reasons for rejection, in his/her written opinion, for example. In the above manner, the user of the conversation device 10 can carry out smoothly his/her task related to obtaining the intellectual property right.

In this application example, the monitoring model 21 determines whether or not the scope of claims, the document related to examination, and the instruction related to them are contained in the input information, and can block the input information in the case where it is determined that they are not contained.

### Application Example 4

In the case where input information contains a sentence written in a first language, for example, the conversation device 10 can determine whether or not the sentence can be easily translated into a second language. For example, in the case where input information contains a sentence “Please classify the following sentence: easy-to-translate into the second language or difficult-to-translate into the second language” and a sentence written in the first language, information indicating whether or not the input sentence is easy to translate can be contained in output information. The output information can be presented to the user of the conversation device 10 by displaying “It is easy to translate.” or “It is difficult to translate. It is recommended to modify the sentence.” on the presentation unit 15, for example. Note that there is no particular limitation on the first language and the second language. Examples of the first language can be Japanese, English, German, French, Chinese, Korean, Spanish, Portuguese, Russian, Arabic, and Hindi. The second language can be a language that is not the first language among the above languages. For example, one of the first language and the second language can be English and the other of the first language and the second language can be Japanese. Note that one or both of the first language and the second language can be a language other than the above-described examples.

Here, in the case where the translation is difficult, the reason for that may be contained in the output information. For example, in the case where translation is difficult because one sentence is long, specifically, the number of words or characters in one sentence is large, information to that effect may be contained in the output information. In this case, for example, “one sentence is long and is difficult to translate. Separation into some sentences is recommended.” can be displayed on the presentation unit 15. In addition, in the case where translation is difficult because of a word that is not easily to understand, information to that effect may be contained in the output information. In this case, for example, “”A“ is not easily understood, so it is recommended to replace it with another word.” is displayed on the presentation unit 15.

In this application example, the monitoring model 21 determines whether or not an instruction related to translation and a sentence are contained, and in the case where it is determined that they are not contained, the input information can be blocked.

The plurality of structure examples described in this specification and the like can be implemented in combination as appropriate.

### REFERENCE NUMERALS

10: conversation device, 11: reception unit, 13: memory unit, 15: presentation unit, 20: processing unit, 21: monitoring model, 23: conversational model, 25: system prompt, 27a: determination model, 27b: determination model, 29: system prompt, 31: input information, 33: output information, 35: error information, 37: error information, 40: data set, 41: learning data, 43: correct label, 51: input determination model, 52: output determination model, 100: terminal, 101: information terminal, 103: information terminal, 105: housing, 107: information terminal, 120: network, 130: server

1. A conversation device comprising:
a reception unit, a processing unit, and a presentation unit;
wherein the reception unit is configured to receive input information,
wherein the processing unit is configured:
to perform processing using a monitoring model; and
to perform processing using a conversational model,
wherein the processing using the monitoring model comprises processing to determine whether or not to transmit the input information transmitted to the conversational model,
wherein the processing using the conversational model comprises a processing to generate output information from the input information,
wherein the presentation unit is configured:
to present the output information when the processing using the monitoring model determines to transmit the input information to the conversational model; and
to present error information showing that the output information is not presented when the processing using the monitoring model determines not transmit the input information to the conversational model,
wherein the conversational model is a language model, and
wherein the monitoring model is a different type of model from the conversational model.

2. The conversation device according to claim 1,
wherein the conversation device comprises a memory unit,
wherein the memory unit is configured to store a system prompt, and
wherein the processing unit is configured to generate the output information using the input information and the system prompt as prompts with the use of the conversational model.

3. The conversation device according to claim 2, wherein the determination uses the system prompt.

4. A conversation device comprising:
a reception unit to configured to receive input information;
a memory unit to configured to store a system prompt;
a processing unit to configured to perform processing using a monitoring model; and
to perform processing using a conversational model; and
a presentation unit;
wherein the processing using the monitoring model comprises processing to determine whether or not to transmit the input information to the conversational model, on the basis of the input information and the system prompt with the use of the monitoring model,
wherein the processing using the conversational model is a processing that the conversational model generates output information using the input information and the system prompt as prompts,
wherein the presentation unit is configured:
to present the output information when the processing using the monitoring model determines to transmit the input information to the conversational model; and
to present error information showing that the output information is not presented when the processing using the monitoring model determines not transmit the input information to the conversational model, and
wherein the conversational model is a language model.

5. The conversation device according to claim 4, wherein the monitoring model is a different type of model from the conversational model.

6. The conversation device according to claim 1, wherein the processing using the monitoring model is further comprises processing to determine whether or not to present the output information.

7. The conversation device according to claim 1, wherein the monitoring model is a machine learning model that has learned using a different data set from a data set used for learning of the conversational model.

8. The conversation device according to claim 1, wherein the monitoring model comprises a first model that is a rule-based model and a second model that is a machine learning model.

9. A conversation method comprising:
a first step of receiving first input information;
a second step of receiving second input information;
a third step of determining whether or not to transmit the second input information to a conversational model, on the basis of the first input information and the second input information by using a monitoring model;
a fourth step of generating output information on the basis of the first input information and the second input information by using the conversational model when the second input information is determined to transmit to the conversational model;
a fifth step of presenting the output information when the output information is generated, and
a sixth step of presenting error information showing that the output information is not presented in the case where the monitoring model does when the second information is determined not to transmit the second input information to the conversational model.

10. The conversation method according to claim 9, wherein the monitoring model is a different type of model from the conversational model.

11. The conversation method according to claim 9, wherein in the fourth step, the conversational model generates the output information using the first input information, the second input information and a system prompt, as prompts.

12. The conversation method according to claim 11, wherein in the third step, the monitoring model uses the system prompt to determine whether or not to transmit the second input information to the conversational model.

13. The conversation method according to according to claim 9, further comprising:
after the fourth step and before the fifth step, a seventh step in which the monitoring model determines whether or not to present the output information, on the basis of the output information.

14. The conversation method according to according to claim 9, wherein the monitoring model is a machine learning model that has learned using a different data set from a data set used for learning of the conversational model.

15. The conversation method according to according to claim 9, wherein the monitoring model comprises a first model that is a rule-based model and a second model that is a machine learning model.

16. The conversation device according to claim 4, wherein the processing using the monitoring model is further comprises processing to determine whether or not to present the output information.

17. The conversation device according to claim 4, wherein the monitoring model is a machine learning model that has learned using a different data set from a data set used for learning of the conversational model.

18. The conversation device according to claim 4, wherein the monitoring model comprises a first model that is a rule-based model and a second model that is a machine learning model.
